(19) United States
(12) Patent Application Publication
(10) Pub. No.: US 2026/0298286 A1
(43) Pub. Date: Oct. 1, 2026

(54) HINGE DEVICE AND FOLDABLE CONTAINER

(71) Applicant: GUANGDONG XINHUI CIMC SPECIAL TRANSPORTATION EQUIPMENT CO. LTD., Jiangmen, Guangdong (CN)

(72) Inventors: Shengqi LI, Jiangmen, Guangdong (CN); Guoquan WU, Jiangmen, Guangdong (CN); Zhenyuan REN, Jiangmen, Guangdong (CN); Qibin WU, Jiangmen Guangdong (CN)

(21) Appl. No.: 19/477,658

(22) PCT Filed: Dec. 26, 2023
(86) PCT No.: PCT/CN2023/141934

§ 371 Date: Oct. 22, 2025

(30) Foreign Application Priority Data
May 6, 2023 (CN) 202310661358.8

(51) Int. Cl. F16C 11/10; B65D 88/52

(52) U.S. Cl. CPC F16C 11/10; B65D 88/522; F16C 2314/00

(57) ABSTRACT

A hinge device and a foldable container are provided. The hinge device includes a fixed hinge, a movable hinge pivotally connected to the fixed hinge and a locking assembly pivotally connected to the fixed hinge about a locking pivot shaft. The locking assembly includes a bracket and a locking block. The bracket includes a pair of side plates, and the locking block is provided with a locking shaft, which is set to movably pass between the pair of side plates. During rotation of the movable hinge from a horizontal position to a vertical position, the locking assembly in a locked position can be pushed to rotate, such that a part of the movable hinge rotated to the vertical position is located below the locking block, thereby enabling the locking block to block rotation of the movable hinge from the vertical position to the horizontal position.

### BACKGROUND

The present disclosure relates to the technical field of foldable containers, and in particular to a hinge device and a foldable container.

The foldable container includes an end frame and a bottom frame. The foldable end frame is hinged to the bottom frame by a hinge device. After the end frame is erected, a bolt of the hinge device needs to be manually operated to lock the end frame. The hinge device generally includes a movable hinge fixedly connected to the lower end of the end frame and a fixed hinge fixedly connected to both sides of the end portion of the bottom frame. The movable hinge is hinged to the fixed hinge by a pin shaft such that the end frame of the container may be flipped in a folded position folded on the bottom frame and an open position disposed in a vertical direction. When the end frame of the container is in the open position, the operator inserts the bolt outward from the inside of the fixed hinge into the corresponding holes or notches of the movable hinge and the fixed hinge, such that the movable hinge is fixed to the fixed hinge, and thus the end frame cannot be flipped from the open position to the folded position under the action of external force. When the end frame of the container needs to be flipped from the open position to the folded position, the operator needs to pull out the bolt in advance.

However, in some cases, the operator may not have inserted the bolt to the correct position. Furthermore, since the bolt is located within the fixed hinge, it is also difficult for the operator to realize that the bolt is not inserted in the correct position. As a result, there will be a greater safety hazard when the operator operates the foldable container.

In order to solve the above problem, the hinge device of the foldable container in related art is provided with a locking assembly. The locking assembly is capable of automatically locking the movable hinge when the end frame is flipped to the open position to lock the end frame in the open position. When it is necessary to flip the end frame to the folded position, the locking assembly needs to be manually moved to unlock the movable hinge. The locking assembly of the hinge device in the related art includes a bracket and a locking block. The bracket is provided with a mounting groove. A part of the locking block is disposed within the mounting groove. The locking block is used to block a rotation of the movable hinge so as to secure the end frame in the open position. During a rotation of the end frame from the folded position to the open position, the movable hinge acts on the locking block to rotate the locking assembly so that the movable hinge may be rotated to the open position. During this process, the locking block is flipped within the mounting groove. In this way, the shape of the mounting groove needs to match the flipping track of the locking block, and the structure of the mounting groove is complex.

Therefore, the present disclosure provides a hinge device and a foldable container to at least partially solve the above-mentioned problems.

### SUMMARY

A series of simplified concepts are introduced into the portion of SUMMARY, which would be further illustrated in the portion of the DETAILED DESCRIPTION. The portion of Summary of the present disclosure is not intended to define the key features and essential technical features of the claimed technical solution, let alone determining the protection scope thereof.

To at least partially solve the above technical problem, the present disclosure provides a hinge device for a foldable container, comprising:
a fixed hinge;
a movable hinge pivotally connected to the fixed hinge between a horizontal position and a vertical position about a hinge pivot shaft with an axial direction parallel to a first horizontal direction; and
a locking assembly pivotally connected to the fixed hinge about a locking pivot shaft with an axial direction parallel to the first horizontal direction to be able to rotate to a locked position,
wherein the locking assembly comprises a bracket and a locking block, the bracket comprises a pair of side plates spaced apart along the first horizontal direction and disposed in the fixed hinge, the movable hinge is located between the pair of side plates, the locking block is provided with a locking shaft, an axial direction of the locking shaft is parallel to the first horizontal direction, and the locking shaft is set to movably pass between the pair of side plates;
during a rotation of the movable hinge from the horizontal position to the vertical position, the locking assembly in the locked position can be pushed to rotate such that a part of the movable hinge rotated to the vertical position is located below the locking block, thereby enabling the locking block to block a rotation of the movable hinge from the vertical position to the horizontal position.

According to the hinge device of the present disclosure, the locking of the movable hinge in the vertical position may be released by moving the locking assembly away from the locked position such that the movable hinge may be rotated towards the horizontal position, which is simple to operate. Furthermore, the setting of the locking block connected to the side plates via the locking shaft allows for a simple structure of the side plates.

Optionally, the each side plate is provided with a retaining hole through which the locking shaft is set to pass, the dimension of the retaining hole is larger than an outer diameter dimension of the locking shaft, such that the locking shaft is movable along any direction within a movement plane perpendicular to the first horizontal direction.

Optionally, the retaining hole is an elongated hole, and a long axis of the elongated hole is parallel to a height direction of the fixed hinge in a case where the locking assembly is in the locked position.

Optionally, the locking block has an accommodating hole with an axial direction parallel to the first horizontal direction and a positioning hole with an axial direction perpendicular to the first horizontal direction, the positioning hole is communicated to the accommodating hole, the locking assembly further comprises a fastener, the locking shaft is set to pass through the accommodating hole, and the fastener is set to pass through the positioning hole and abuts against the locking shaft.

Optionally, the fixed hinge is provided with an avoidance hole, the locking assembly is provided with a blocking portion extending along the first horizontal direction, the blocking portion and the locking pivot shaft are spaced apart, and the blocking portion extends and protrudes to a first side of the fixed hinge along the first horizontal direction after passing through the avoidance hole; and

the hinge device further comprises an operating member comprising a mating portion located at the first side of the fixed hinge along the first horizontal direction, the operating member is pivotally connected to the fixed hinge or to the locking assembly about a flipping pivot shaft with an axial direction parallel to the first horizontal direction, and the mating portion is rotatable to a side of the blocking portion along a second horizontal direction perpendicular to the first horizontal direction such that the mating portion is capable of driving the locking assembly to rotate away from the locked position via the blocking portion.

Optionally, the operating member further comprises an operating portion, the mating portion comprises a first wall and a second wall connected to the second wall, one end of the second wall is connected to the operating portion, length directions of the first wall and the second wall are both perpendicular to the first horizontal direction, a length direction of the operating portion extends along the first horizontal direction, and the first wall is used to push the blocking portion to drive the locking assembly to rotate away from the locked position.

Optionally, the operating member passes through a stowed position, a first flipped position and a second flipped position in sequence during a rotation of the operating member about the flipping pivot shaft in a clockwise direction or in a counterclockwise direction;

in a case where the operating member is in the stowed position, the operating member is located at an inner side of an outer end of the fixed hinge along the second horizontal direction, and the first wall is spaced apart from the blocking portion;

in a case where the operating member is in the first flipped position, the operating portion is located at an outer side of the fixed hinge along the second horizontal direction, the blocking portion is located between the operating portion and the first wall, the first wall abuts against the blocking portion, and the locking assembly is in the locked position; and

in a case where the operating member is in the second flipped position, the first wall abuts against the blocking portion, and the locking assembly is in a released position.

Optionally, in the case where the operating member is in the first flipped position, the second wall is located below the first wall, and the flipping pivot shaft is located between the operating portion and the first wall along the second horizontal direction, and/or

in the case where the operating member is in the stowed position, the blocking portion is located at a side of the second wall and fits against the second wall, thereby blocking the operating member from rotating away from the first flipped position.

Optionally, the operating member is capable of stopping at the stowed position or at the first flipped position under the action of gravity of the operating member.

Optionally, the flipping pivot shaft and the locking pivot shaft are provided coaxially or spaced apart.

Optionally, the fixed hinge comprises a wall plate, a bottom corner piece connected to a lower end of the wall plate and a supporting plate, there is a spacing between a fixed outer side surface of the wall plate and a corner piece outer side surface of the bottom corner piece along the first horizontal direction, the supporting plate fits against the fixed outer side surface, a supporting outer side surface of the supporting plate is flush with the corner piece outer side surface along the first horizontal direction, and the mating portion fits against the supporting plate, and/or

the side plates comprise an outer side plate and an inner side plate spaced apart along the first horizontal direction, and the bracket further comprises a connecting member connected to the top of an outer end of the outer side plate and to the top of an outer end of the inner side plate.

The present disclosure further provides a foldable container, comprising the above-mentioned hinge device.

According to the foldable container of the present disclosure, the foldable container includes the above-mentioned hinge device. The locking of the movable hinge in the vertical position may be released by moving the locking assembly away from the locked position such that the movable hinge may be rotated towards the horizontal position, which is simple to operate. Furthermore, the setting of the locking block connected to the side plates via the locking shaft allows for a simple structure of the side plates.

### BRIEF DESCRIPTION OF THE DRAWINGS

In order to make the advantages of the present disclosure more readily understood, the present disclosure, briefly described above, will be described in more detail by reference to specific embodiments illustrated in the drawings. It will be appreciated that these drawings depict exemplary embodiments of the present disclosure only and therefore should not be considered as limiting the protection scope thereof, and that the present disclosure is described and explained with additional features and details by the drawings.

FIG. 1 is a perspective schematic view of a hinge device according to a first optional embodiment of the present disclosure, wherein a movable hinge is in a vertical position, an operating member is in a first flipped position, and a locking assembly is in a locked position;

FIG. 2 is a perspective schematic view of the hinge device in FIG. 1, wherein the movable hinge is in a horizontal position, the operating member is in a stowed position, and the locking assembly is in the locked position;

FIG. 3 is a perspective schematic view of the hinge device in FIG. 1, wherein the movable hinge is between the vertical position and the horizontal position, the operating member is in a second flipped position, and the locking assembly is in a released position;

FIG. 4 is a perspective schematic view of a fixed hinge of the hinge device in FIG. 1;

FIG. 5 is a perspective schematic view of the movable hinge of the hinge device in FIG. 1;

FIG. 6 is a perspective schematic view of the locking assembly of the hinge device in FIG. 1, without showing a blocking portion;

FIG. 7 is an exploded schematic view of the locking assembly of the hinge device in FIG. 1;

FIG. 8 is a perspective schematic view of a flipping member of the hinge device in FIG. 1;

FIG. 9 is a sectional schematic view of the hinge device in FIG. 1, wherein the movable hinge is not shown, the operating member is in the stowed position, and the locking assembly is in the locked position;

FIG. 10 is a sectional schematic view of the hinge device in FIG. 1, wherein the movable hinge is not shown, the operating member is in the first flipped position, and the locking assembly is in the locked position;

FIG. 11 is a sectional schematic view of the hinge device in FIG. 1, wherein the movable hinge is not shown, the operating member is in the second flipped position, and the locking assembly is in the released position;

FIG. 12 is a sectional schematic view of a hinge device according to a second optional embodiment of the present disclosure, wherein the movable hinge is not shown, the operating member is in the first flipped position, and the locking assembly is in the locked position; and

FIG. 13 is a perspective schematic view of a foldable container according to an optional embodiment of the present disclosure, wherein an end frame is in an open position.

### EXPLANATION OF REFERENCE NUMERALS

| | |
|---|---|
| 110: Fixed hinge | 111: Outer wall plate |
| 112: Clamping block | 113: Locking surface |
| 114: Inner wall plate | 114a: Avoidance hole |
| 115: Outer hinge shaft hole | 116: Bottom corner piece |
| 117: Hanging corner piece | 118: Locking shaft hole |
| 119: Supporting plate | 120: Movable hinge |
| 121: Protruding portion | 122: Supporting surface |
| 123: Inner hinge shaft hole | 124: Abutment surface |
| 130: Hinge pivot shaft | 140: Locking assembly |
| 141: Bracket | 142: Through hole |
| 143: Locking block | 144: Locking pivot shaft |
| 145: Outer side plate | 146: Connecting member |
| 147: Positioning hole | 148: Accommodating hole |
| 149: Locking shaft | 151: Retaining hole |
| 152: Blocking portion | 153: Side plate pin shaft hole |
| accommodating hole | |
| 154: Inner side plate | 155: Blocking portion |
| 160: Operating member | 161: Operating portion |
| 162: Mating portion | 162a: First mating surface |
| 162b: Second mating surface | 162c: First wall |
| 162d: Second wall | 163: Connection hole |
| 170: Flipping pivot shaft | F: Outer end surface of bottom |
| | corner piece |
| 260: Operating member | 261: Operating portion |
| 262: Mating portion | |

### DETAILED DESCRIPTION

In the following description, numerous specific details are set forth in order to provide a more thorough understanding of the present disclosure. However, it is obvious to those skilled in the art that the embodiments of the present disclosure may be implemented without one or more of these details. Some technical features well-known in this art are not described in other examples in order to avoid confusion with the embodiments of the present disclosure.

The optional embodiments of the present disclosure will be explained below with reference to the accompanying drawings. It should be noted that the terms “upper”, “lower”, and similar expressions used herein are for illustrative purposes only and are not restrictive.

Ordinals such as “first” and “second” quoted in this disclosure are merely identifications and do not have any other meaning, such as a specific order.

In order to thoroughly understand the embodiments of the present disclosure, detailed structures will be set forth in the following description. Obviously, the implementation of the embodiments of the present disclosure is not limited to the specific details familiar to those skilled in the art. The preferred embodiments of the present disclosure are illustrated in detail as below. However, the present disclosure may further have other embodiments in addition to these detailed descriptions.

### First Example

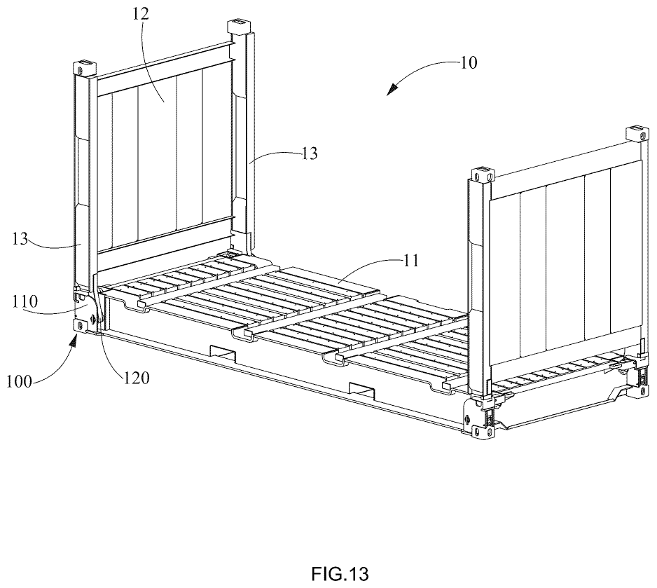

The present disclosure provides a hinge device 100 and a foldable container 10 (e.g., a platform-based container) having the hinge device 100. Referring to FIG. 13, the foldable container 10 mainly comprises a bottom frame 11 disposed in a horizontal direction and end frames 12. The bottom frame 11 is generally configured as a rectangular frame structure. Two ends of the end frame 12 along a width direction of the bottom frame 11 are provided with corner posts 13.

The end frames 12 are disposed at two ends of the bottom frame 11 along a length direction of the bottom frame 11. The end frame 12 is rotatable between a folded position and an open position. In a case where the end frame 12 is in the folded position, the end frame 12 is folded on the bottom frame 11, and a height direction of the end frame 12 (i.e., a length direction of the corner post 13 of the end frame 12) is parallel to the length direction of the bottom frame 11. In a case where the end frame 12 is in the open position, the height direction of the end frame 12 is parallel to a height direction of the bottom frame 11.

The end frame 12 is pivotally connected to the bottom frame 11 by the hinge device 100. The hinge device 100 is disposed at a corner portion of the bottom frame 11 and is disposed at a lower end of the corner post 13 of the end frame 12.

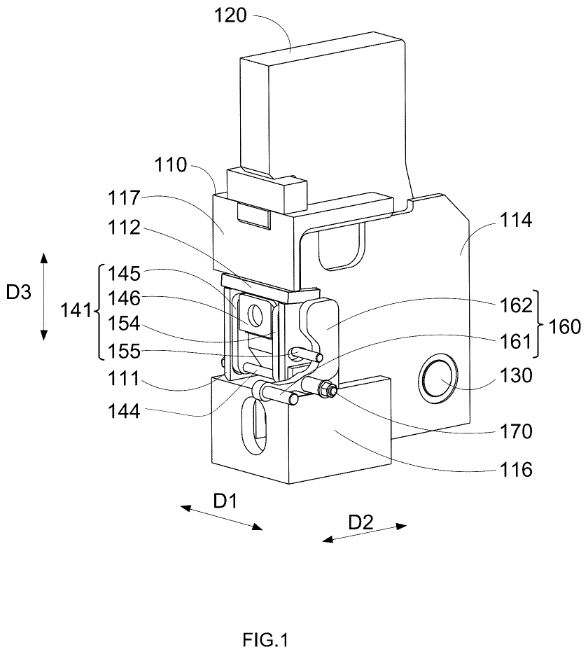

Referring to FIGS. 1 to 11, the hinge device 100 includes a fixed hinge 110, a movable hinge 120, a locking assembly 140, and an operating member 160.

The fixed hinge 110 is used to be fixedly connected to the bottom frame 11. At this time, the fixed hinge 110 is located at a corner portion of the bottom frame 11. The movable hinge 120 is used to be connected to the bottom end of the corner post 13 of the end frame 12. At this time, the width direction of the bottom frame 11 is parallel to a first horizontal direction D1, the length direction of the bottom frame 11 is parallel to a second horizontal direction D2, and the height direction of the bottom frame 11 is parallel to a height direction D3 of the fixed hinge 110.

As shown in FIGS. 1 to 4, the fixed hinge 110 includes an outer wall plate 111 and an inner wall plate 114. The plane where the outer wall plate 111 is located is parallel to the plane where the inner wall plate 114 is located. The outer wall plate 111 and the inner wall plate 114 are spaced apart along the first horizontal direction D1. The outer wall plate 111 and the inner wall plate 114 are connected by a bottom corner piece 116 and a hanging corner piece 117 as described hereinafter. In the case where the fixed hinge 110 is connected to the bottom frame 11, the inner wall plate 114 is disposed on an inner side of the outer wall plate 111 close to a center of the bottom frame 11 along the width direction of the bottom frame 11.

Herein, the “inner side”, “outer side”, “inner end” and “outer end” of the parts along an illustrative direction (the first horizontal direction D1, the second horizontal direction D2, or the height direction D3 of the fixed hinge 110) are the “inner side”, “outer side”, “inner end” and “outer end” of the parts in the case where the hinge device 100 is connected to the bottom frame 11. For example, the inner end of the part along the first horizontal direction Dlis an end of the part close to the center of the bottom frame 11 along the first horizontal direction D1 in the case where the hinge device 100 is connected to the bottom frame 11.

The outer end of the part along the first horizontal direction D1 is an end of the part away from the center of the bottom frame 11 along the first horizontal direction D1 in the case where the hinge device 100 is connected to the bottom frame 11.

The inner side of the part along the first horizontal direction D1 is a side of the part close to the center of the bottom frame 11 along the first horizontal direction D1 in the case where the hinge device 100 is connected to the bottom frame 11.

The outer side of the part along the first horizontal direction D1 is a side of the part away from the center of the bottom frame 11 along the first horizontal direction D1 in the case where the hinge device 100 is connected to the bottom frame 11.

Referring to FIGS. 1 to 5, the hinge device 100 further comprises a hinge pivot shaft 130. The hinge pivot shaft 130 may be substantially configured as a circular columnar structure. The movable hinge 120 may be provided with an inner hinge shaft hole 123. Each of the bottom of the inner end of the outer wall plate 111 and the bottom of the inner end of the inner wall plate 114 along the second horizontal direction D2 is provided with an outer hinge shaft hole 115.

The movable hinge 120 is disposed between the outer wall plate 111 and the inner wall plate 114. The hinge pivot shaft 130 is set to pass through the inner hinge shaft hole 123 and the outer hinge shaft holes 115. In this case, an axial direction of the hinge pivot shaft 130 is parallel to the first horizontal direction D1. In this way, the movable hinge 120 is pivotally connected to the fixed hinge 110 via the hinge pivot shaft 130 such that the movable hinge 120 is rotatable about the hinge pivot shaft 130 relative to the fixed hinge 110 between a horizontal position and a vertical position.

When the movable hinge 120 is in the horizontal position, the movable hinge 120 is disposed substantially in the horizontal direction. At this time, the end frame 12 is in the folded position. When the movable hinge 120 is in the vertical position, the movable hinge 120 is disposed substantially along the height direction D3 of the fixed hinge 110. At this time, the end frame 12 is in the open position.

In this embodiment, one end of the movable hinge 120 is located within a spacing between the outer wall plate 111 and the inner wall plate 114. The other end of the movable hinge 120 extends out of the outer wall plate 111 and the inner wall plate 114 for connection with the corner post 13 of the end frame 12.

Referring to FIGS. 1 to 3 and FIGS. 6 and 7, the locking assembly 140 includes a bracket 141, a locking block 143, and a locking pivot shaft 144. The bracket 141 includes a pair of side plates. The pair of side plates includes an outer side plate 145 and an inner side plate 154. The plane where the outer side plate 145 is located is parallel to the plane where the inner side plate 154 is located. The outer side plate 145 and the inner side plate 154 are spaced apart along the first horizontal direction D1. The outer side plate 145 and the inner side plate 154 are connected by the connecting member 146 as described hereinafter.

The plane where the outer side plate 145 is located is substantially parallel to the plane where the outer wall plate 111 is located. Along the first horizontal direction D1, the outer side plate 145 is located between the outer wall plate 111 and the movable hinge 120, and the inner side plate 154 is located between the inner wall plate 114 and the movable hinge 120.

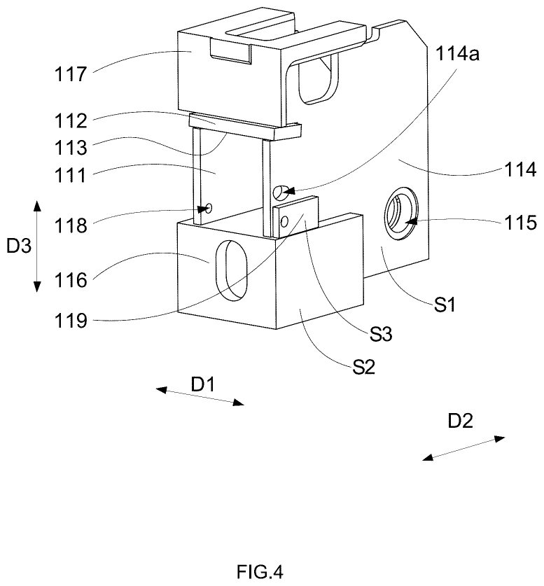

The locking pivot shaft 144 may be substantially configured as a circular columnar structure. Along the second horizontal direction D2, each of the bottom of the outer end of the outer side plate 145 and the bottom of the outer end of the inner side plate 154 is provided with a side plate pin shaft hole 153. The outer wall plate 111 and the inner wall plate 114 are each provided with a corresponding locking shaft hole 118 (see FIG. 4). The locking pivot shaft 144 is set to pass through the side plate pin shaft holes 153 and the locking shaft holes 118. Thus, there is a spacing between the locking pivot shaft 144 and the hinge pivot shaft 130 along the second horizontal direction D2. The bracket 141 is pivotally connected to the fixed hinge 110 via the locking pivot shaft 144 such that the locking assembly 140 is rotatable about the locking pivot shaft 144 relative to the fixed hinge 110 between a locked position and a released position.

It should be noted that the “top”, “bottom”, “outer end” and “inner end” of the parts in the locking assembly 140 are all the “top”, “bottom”, “outer end” and “inner end” when the locking assembly 140 is in the locked position.

The locking block 143 is movably connected to the bracket 141 (which will be described hereinafter). The locking block 143 is located between the outer side plate 145 and the inner side plate 154 along the first horizontal direction D1.

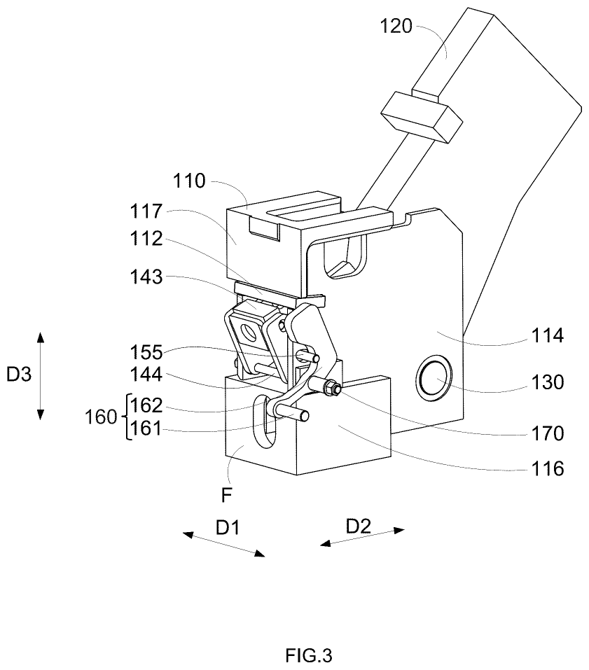

When the locking assembly 140 is in the locked position (see FIG. 1), the locking assembly 140 is capable of locking the movable hinge 120 in the vertical position, which in turn locks the end frame 12 connected to the movable hinge 120 in the open position. When the locking assembly 140 is in the released position, it is able to unlock the movable hinge 120 in the vertical position, thereby allowing the end frame 12 to be rotated from the open position to the folded position (see FIG. 3).

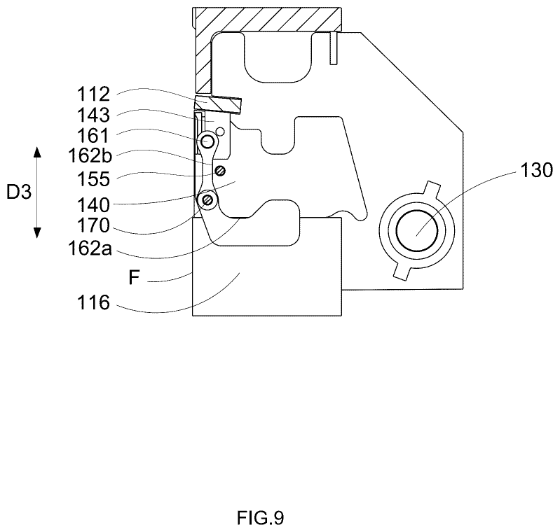

Specifically, as shown in FIGS. 9 to 11, along the second horizontal direction D2, the center of gravity of the locking assembly 140 is located at a side of an axis of the locking pivot shaft 144 close to the hinge pivot shaft 130. In this way, in a case where the locking assembly 140 is in the released position, the upper portion of the outer end of the locking assembly 140 is located on the outer side of the fixed hinge 110 along the second horizontal direction D2. The rotation angle of the locking assembly 140 between the locked position and the released position is small, such that the locking assembly 140 in the released position may automatically return to the locked position under the action of its own gravity in the absence of an external force. That is, the locking assembly 140 is able to remain in the locked position without being subjected to the external force.

In a case where the movable hinge 120 is in the horizontal position, the movable hinge 120 is spaced apart from the locking assembly 140. At this time, the locking assembly 140 is in the locked position. During a rotation of the movable hinge 120 from the horizontal position to the vertical position (as shown in FIGS. 1 to 3, the movable hinge 120 is rotated about the hinge pivot shaft 130 in a counterclockwise direction), the movable hinge 120 may contact and push the locking block 143 of the locking assembly 140, thereby rotating the locking assembly 140 away from the locked position towards the released position (the locking assembly 140 is rotated about the locking pivot shaft 144 in a counterclockwise direction). During this process, the locking assembly 140 and the movable hinge 120 rotate at the same time, and the locking assembly 140 may gradually avoid the movable hinge 120, thereby enabling the movable hinge 120 to rotate to the vertical position. In a case where the movable hinge 120 is rotated to the vertical position, the movable hinge 120 is spaced apart from the locking block 143, thereby releasing its action on the locking block 143. At this time, the locking assembly 140 may automatically rotate to the locked position under the action of its own gravity (the locking assembly 140 rotates about the locking pivot shaft 144 in a clockwise direction).

In a case where the movable hinge 120 is in the vertical position and the locking assembly 140 is in the locked position, at least a part of the movable hinge 120 is located below the locking block 143. At this time, the locking block 143 is capable of blocking the movable hinge 120 from rotating towards the horizontal position to lock the movable hinge 120 in the vertical position.

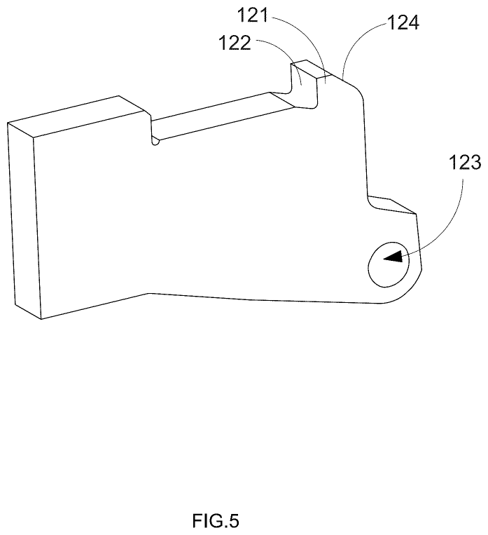

Optionally, as shown in FIG. 5, the movable hinge 120 is provided with a protruding portion 121. Along the second horizontal direction D2, the protruding portion 121 is disposed at an outer end of the movable hinge 120. The protruding portion 121 may include an upward supporting surface 122.

It should be noted that the “top”, “bottom”, “outer end” and “inner end” of the parts of the movable hinge 120 all are the “top”, “bottom”, “outer end” and “inner end” when the movable hinge 120 is in the vertical position.

During the rotation of the movable hinge 120 from the horizontal position to the vertical position, the protruding portion 121 may abut against the locking block 143 and exert a thrust on the locking block 143, causing the locking assembly 140 to rotate away from the locked position. When the movable hinge 120 is in the vertical position, there is a spacing between the portion of the movable hinge 120 located above the supporting surface 122 and the locking block 143 along the second horizontal direction D2. In this way, the movable hinge 120 is able to avoid the locking block 143 to release its action on the locking block 143. As a result, the locking assembly 140 automatically flips back to the locked position under the action of its own gravity. In this way, the supporting surface 122 is located below the locking block 143 and may abut against the locking block 143 such that the locking block 143 may be clamped between the supporting surface 122 of the protruding portion 121 and the fixed hinge 110 along the height direction D3 of the fixed hinge 110, thereby locking the movable hinge 120 in the vertical position.

The protruding portion 121 may also be provided with an abutment surface 124. The supporting surface 122 is arranged obliquely with respect to the abutment surface 124 (see FIG. 5). In this embodiment, when the movable hinge 120 is in the vertical position, the upper end of the abutment surface 124 is further away from the inner hinge shaft hole 123 relative to the lower end thereof along the second horizontal direction D2. During the rotation of the movable hinge 120 from the horizontal position to the vertical position, the abutment surface 124 may abut against the locking block 143 and push the locking assembly 140 away from the locked position.

When it is necessary to rotate the movable hinge 120 from the vertical position to the horizontal position, the operating member 160 may be operated to drive the locking assembly 140 to rotate to the released position, thereby releasing the locking block 143 from locking the movable hinge 120 in the vertical position. In this way, the movable hinge 120 in the vertical position may be rotated towards the horizontal position.

Specifically, as shown in FIGS. 1 to 3, the bracket 141 is provided with a blocking portion 155. The blocking portion 155 may be a rod-like structure. A length direction of the blocking portion 155 extends along the first horizontal direction D1. The blocking portion 155 and the locking pivot shaft 144 are spaced apart. Along the height direction D3 of the fixed hinge 110, the blocking portion 155 is located above the locking pivot shaft 144. The inner wall plate 114 is provided with an avoidance hole 114a. The blocking portion 155 is set to pass through the avoidance hole 114a. Along the first horizontal direction D1, the blocking portion 155 extends and protrudes to the inner side (an example of the first side) of the inner wall plate 114 away from the outer wall plate 111. A dimension of the avoidance hole 114a is larger than an outer diameter dimension of the blocking portion 155.

It will be appreciated that in an optional embodiment, the avoidance hole is provided in the outer wall plate. Along the first horizontal direction D1, the blocking portion may also extend and protrude to the outer side of the outer wall plate away from the inner wall plate, and the operating member is located at the outer side of the outer wall plate.

A flipping pivot shaft 170 may be substantially configured as a circular columnar structure. The operating member 160 is provided with a connection hole 163. The flipping pivot shaft 170 is connected to the inner wall plate 114. Along the first horizontal direction D1, the operating member 160 is located at the inner side of the inner wall plate 114. The flipping pivot shaft 170 is set to pass through the connection hole 163. In this way, the operating member 160 is pivotally connected to the fixed hinge 110 by the flipping pivot shaft 170 such that the operating member 160 is rotatable relative to the fixed hinge 110 about the flipping pivot shaft 170. Thus, the operating member 160 is rotatable relative to the fixed hinge 110 between a stowed position, a first flipped position and a second flipped position. In the embodiment illustrated in FIG. 1, the operating member 160 is first rotated about the flipping pivot shaft 170 from the stowed position to the first flipped position in a counterclockwise direction, and then continues to be rotated in a counterclockwise direction from the first flipped position to the second flipped position. As a result, the hinge device 100 is simple in structure and easy to operate.

The operating member 160 includes an operating portion 161 and a mating portion 162. As shown in FIG. 1, in a case where the operating member 160 is in the first flipped position, along the second horizontal direction D2, a part of the mating portion 162 is located at a side of the blocking portion 155 close to the hinge pivot shaft 130. That is, in the illustrated embodiment, the part of the mating portion 162 is located upstream of the blocking portion 155 in the counterclockwise direction around the flipping pivot shaft 170. The mating portion 162 abuts against the blocking portion 155. At this time, by rotating the operating member 160 towards the second flipped position, the blocking portion 155 may be pushed to move within the avoidance hole 114a, which in turn pushes the locking assembly 140 to rotate away from the locked position towards the released position.

In the setting that the mating portion 162 of the operating member 160 is located at the side of the fixed hinge 110 along the second horizontal direction D2, the mating portion 162 of the operating member 160 may not be blocked by the fixed hinge 110, which may facilitate the operation of the mating portion 162 of the operating member 160.

Thus, in a case where the movable hinge 120 in the vertical position needs to be rotated towards the horizontal position, the operating member 160 may be operated to drive the locking assembly 140 from the locked position to the released position to allow the rotation of the movable hinge 120 towards the horizontal position.

Optionally, with reference to FIGS. 1 to 3 and FIGS. 6 and 7, the bracket 141 further comprises a connecting member 146. Along the second horizontal direction D2, the connecting member 146 is connected to the top of the outer end of the outer side plate 145 and the top of the outer end of the inner side plate 154. The connecting member 146 has a through hole 142. As a result, the bracket 141 has low weight and high strength.

The inner side plate 154 is provided with a blocking portion accommodating hole 152. One end of the blocking portion 155 is set to pass through the blocking portion accommodating hole 152 and connected to the inner side plate 154. At this time, the other end of the blocking portion 155 is located at a side of the inner side plate 154 away from the outer side plate 145. As a result, the hinge device 100 is simple in structure and easy to install.

It will be appreciated that in an optional embodiment, the blocking portion may also be located between the inner side plate and the inner wall plate. In this case, no avoidance holes are required. The mating portion of the operating member is located between the inner side plate and the inner wall plate. The operating member may also be pivotally connected to the bracket.

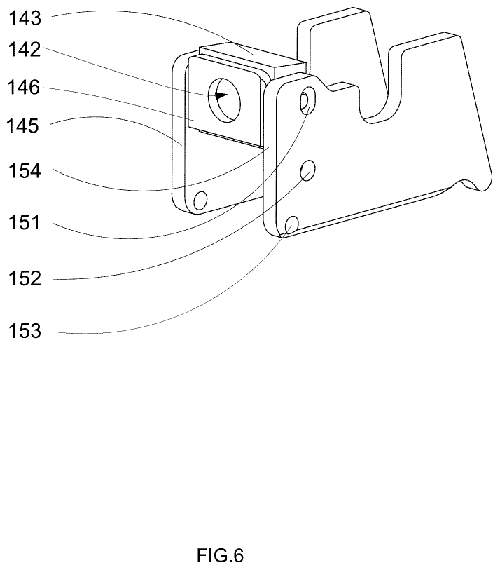

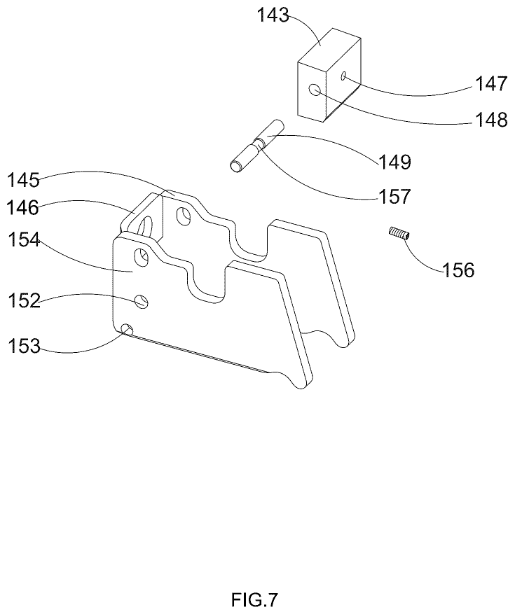

As shown in FIGS. 6 and 7, each of the inner side plate 154 and the outer side plate 145 has a retaining hole 151. The locking block 143 has a positioning hole 147 and an accommodating hole 148. An axial direction of the positioning hole 147 is perpendicular to the first horizontal direction D1. An axial direction of the accommodating hole 148 is parallel to the first horizontal direction D1. The positioning hole 147 is communicated to the accommodating hole 148. The locking assembly 140 further comprises a locking shaft 149, which is set to pass through the accommodating hole 148. The locking shaft 149 may be secured (e.g., welded or connected by a positioning pin) to the locking block 143 via the positioning hole 147, thereby securing the position between the locking shaft 149 and the locking block 143 along the axial direction of the accommodating hole 148.

Optionally, in the embodiment as shown in FIG. 7, the locking assembly 140 includes a fastener 156 such as a setting screw, etc. The fastener 156 is set to pass through the positioning hole 147 and abuts against the locking shaft 149 to secure the locking shaft 149 to the locking block 143, thereby securing the position between the locking shaft 149 and the locking block 143 along the axial direction of the accommodating hole 148.

Optionally, in the embodiment as shown in FIG. 7, the locking shaft 149 includes a slot 157. The fastener 156 is set to pass through the positioning hole 147 and abuts against the slot 157 of the locking shaft 149 to secure the locking shaft 149 to the locking block 143. The slot 157 is optionally disposed at a central location of the locking shaft 149 along an axial direction of the locking shaft 149. The slot 157 is optionally configured as a recessed portion recessed from a peripheral surface of the locking shaft 149 towards a central axis of the locking shaft 149 in a radial direction of the locking shaft 149. Optionally, the slot 157 is provided continuously along a circumferential direction of the locking shaft 149.

The locking shaft 149 is set to pass through the retaining holes 151. Thus, the locking block 143 may be retained between the retaining holes 151 via the locking shaft 149. The retaining hole 151 may be an elongated hole. In the case where the locking assembly 140 is in the locked position, a long axis of the elongated hole is parallel to the height direction D3 of the fixed hinge 110, and a short axis of the elongated hole is parallel to the second horizontal direction D2. The dimensions of the retaining hole 151 along the directions of the long axis and the short axis are both larger than the diameter of the locking shaft 149. In this way, the locking shaft 149 is movable within the retaining hole 151 along any direction within a movement plane, thus being movably connected to the bracket 141. This in turn allows the locking block 143 to be movably connected to the bracket 141. The movement plane is perpendicular to the first horizontal direction D1. As a result, it is convenient for the movement of the locking block 143, and the movable hinge 120 may be smoothly rotated to the vertical position. Moreover, the hinge device 100 is simple in structure and easy to install.

The locking block 143 is located at the connecting member 146. Accordingly, the connecting member 146 may protect the locking block 143 and limit the pivoting of the locking block 143 about the locking shaft 149.

In this embodiment, the locking of the movable hinge 120 in the vertical position may be released by moving the locking assembly 140 away from the locked position such that the movable hinge 120 may be rotated towards the horizontal position, which is simple to operate. Furthermore, the setting of the locking block 143 connected to the side plates via the locking shaft 149 allows for a simple structure of the side plates.

Referring back to FIGS. 1 to 4, the fixed hinge 110 further comprises a bottom corner piece 116 and a hanging corner piece 117. The bottom corner piece 116 may be a bottom corner piece for use in the foldable container 10 in the prior art, and the hanging corner piece 117 may be a hanging corner piece for use in the foldable container 10 in the prior art, which are not detailed here.

The bottom corner piece 116 is disposed to the lower portions of the outer wall plate 111 and the inner wall plate 114 (see FIG. 4). The hanging corner piece 117 is connected to the upper portions of the outer wall plate 111 and the inner wall plate 114. Along the second horizontal direction D2, both the bottom corner piece 116 and the hanging corner piece 117 are disposed at the outer end of the outer wall plate 111 and the outer end of the inner wall plate 114.

Along the first horizontal direction D1, there is a spacing between a fixed inner side surface of the inner wall plate 114 away from the outer wall plate 111 and a corner piece outer side surface S2 of the bottom corner piece 116 away from the outer wall plate 111. The fixed hinge 110 further includes a supporting plate 119. The supporting plate 119 fits against the fixed inner side surface of the inner wall plate 114. A supporting outer side surface S3 of the supporting plate 119 away from the outer wall plate 111 is flush with the corner piece outer side surface. The mating portion 162 fits against the supporting plate 119. Thus, the operating member 160 is rotated smoothly.

Optionally, the fixed hinge 110 further comprises a clamping block 112. The clamping block 112 is connected to a lower end of the hanging corner piece 117. Along the second horizontal direction D2, the clamping block 112 is disposed at the outer end of the outer wall plate 111 and the outer end of the inner wall plate 114, and is connected to the outer wall plate 111 and the inner wall plate 114. The lower surface of the clamping block 112 is a locking surface 113. When the movable hinge 120 is in the vertical position and the locking assembly 140 is in the locked position, the locking block 143 may be clamped between the locking surface 113 and the supporting surface 122 along the height direction D3 of the fixed hinge 110.

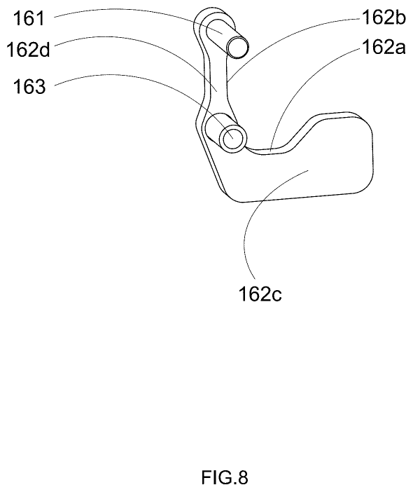

Optionally, referring to FIG. 8, the mating portion 162 includes a first wall 162c and a second wall 162d. The second wall 162d is provided with a connection hole 163. The first wall 162c is used to push the blocking portion 155. One end of the second wall 162d is connected to one end of the first wall 162c. The other end of the second wall 162d is connected to one end of the operating portion 161. The first wall 162c and the second wall 162d are both elongated structures. A length direction of the first wall 162c is perpendicular to a length direction of the second wall 162d. The plane formed by the length directions of the first wall 162c and the second wall 162d is perpendicular to the first horizontal direction D1. Wherein the first wall 162c has a first mating surface 162a. The first wall 162c abuts against the blocking portion 155 by the first mating surface 162a. The second wall 162d has a second mating surface 162b. Thus, the structure of the operating member 160 is simple.

Optionally, the first wall 162c and the second wall 162d form a substantially L-shaped structure. As a result, the structure of the operating member 160 is simple.

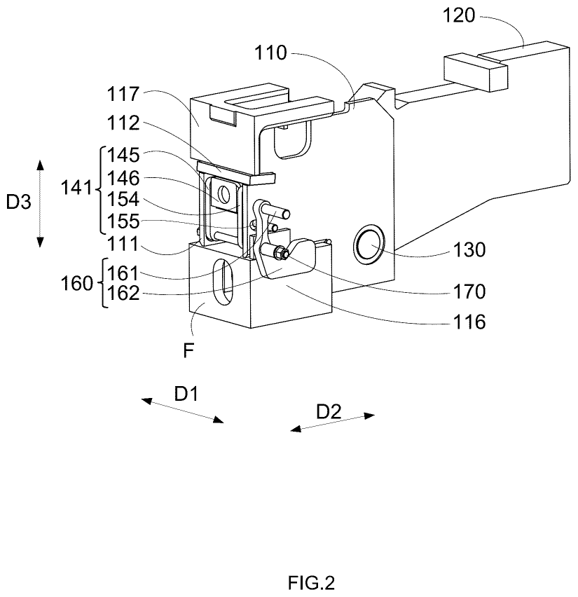

Referring back to FIG. 2, in a case where the operating member 160 is in the stowed position, along the second horizontal direction D2, the operating member 160 is located at the inner side of the outer end surface F of the bottom corner piece at the outer end of the fixed hinge 110, and the first wall 162c is spaced apart from the blocking portion 155. At this time, the locking assembly 140 is in the locked position. As a result, it is possible to protect the operating member 160 and facilitate transportation of the foldable container 10 provided with the hinge device 100.

In a case where the operating member 160 is in the first flipped position and the second flipped position, the operating portion 161 is located at the outer side of the fixed hinge 110 along the second horizontal direction D2. Thus, it is convenient to operate the operating portion 161.

In the case where the operating member 160 is in the first flipped position, the blocking portion 155 is located between the operating portion 161 and the first wall 162c along the second horizontal direction D2. The second wall 162d is located below the first wall 162c. In this way, the operating portion 161, the mating portion 162 and the flipping pivot shaft 170 form a lever structure. By operating the operating portion 161 to drive the mating portion 162 to rotate, the first wall 162c is brought into contact with the blocking portion 155, and the transfer of force to the blocking portion 155 is realized. In this way, by applying a downward force (e.g., by stepping downward on the operating portion 161) to the operating portion 161, the locking assembly 140 in the locked position may be moved towards the released position.

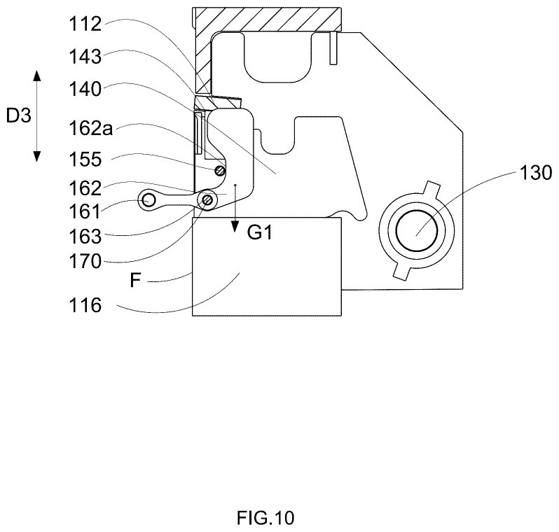

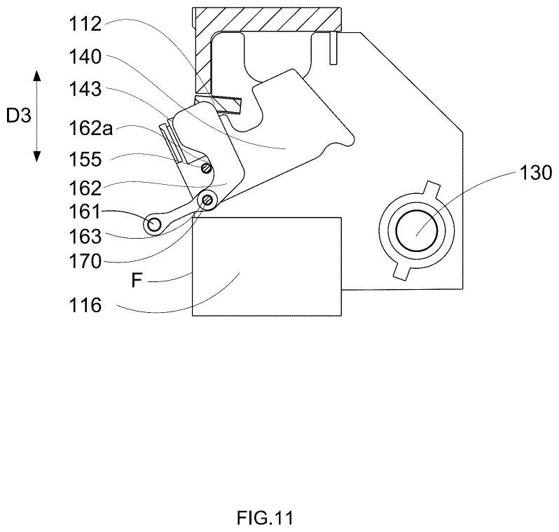

In the case where the operating member 160 is in the second flipped position (the locking assembly 140 is in the released position), as shown in FIGS. 3 and 11, if the downward force applied to the operating portion 161 of the operating member 160 is removed by the user, the locking assembly 140 returns to the locked position under the action of its own gravity and rotates the operating member 160 via the blocking portion 155 to the first flipped position as shown in FIG. 10.

Referring to FIG. 10, along the second horizontal direction D2, the center of gravity of the operating member 160 is located at the side of the flipping pivot shaft 170 close to the outer hinge shaft hole 115 (G1 in FIG. 10 is the location of the center of gravity of the operating member 160). In this way, when the operating member 160 is in the first flipped position or the second flipped position, the operating member 160 will automatically return to the stowed position (the position shown in FIG. 9) due to the action of gravity, thereby enabling the operating member 160 to remain stably in the stowed position when not in use.

It will be appreciated that in the optional embodiment, a reset spring (e.g. a torsion spring) may also be provided. The reset spring is used to apply a restoring force to the operating member. The restoring force enables the operating member to automatically return to the stowed position.

As shown in FIGS. 1 to 3, the flipping pivot shaft 170 and the locking pivot shaft 144 are provided coaxially. Optionally, the flipping pivot shaft 170 and the locking pivot shaft 144 may be the same part. As a result, the hinge device 100 has a simple structure.

In the case where the operating member 160 is in the stowed position, as shown in FIG. 9, the second mating surface 162b is in contact with the blocking portion 155 so as to block the movement of the operating member 160 along a rotation direction from the stowed position away from the first flipped position.

In this embodiment, the locking assembly 140 may be moved from the locked position towards the released position by an operator with stepping on the operating portion 161 of the operating member 160 with the foot. At the same time, the end frame 12 is rotated by the hand from the open position towards the folded position, and vice versa. In this way, the folding (a rotation of the end frame 12 to the folded position) and assembling (a rotation of the end frame 12 to the open position) operations of the foldable container 10 may be completed by one operator alone, which is easy to use and saves labor.

Optionally, the operating portion 161 includes a cylindrical portion. In the case where the operating member 160 is in the first flipped position, a distance between an axis of the cylindrical portion and an axis of the flipping pivot shaft 170 is greater than a distance between an axis of the blocking portion 155 and the axis of the flipping pivot axis 170. As a result, the operating portion 161 may be operated with a smaller force.

In this embodiment, the operating member 160 is not connected to the locking block 143, and does not restrict the movement of the locking block 143.

The present disclosure further provides a foldable container 10 comprising the aforementioned hinge device 100.

In this embodiment, the foldable container 10 includes the aforementioned hinge device 100. The locking of the movable hinge 120 in the vertical position may be released by moving the locking assembly 140 away from the locked position such that the movable hinge 120 may be rotated towards the horizontal position, which is simple to operate. Furthermore, the setting of the locking block 143 connected to the side plates via the locking shaft 149 allows for a simple structure the side plates.

### Second Embodiment

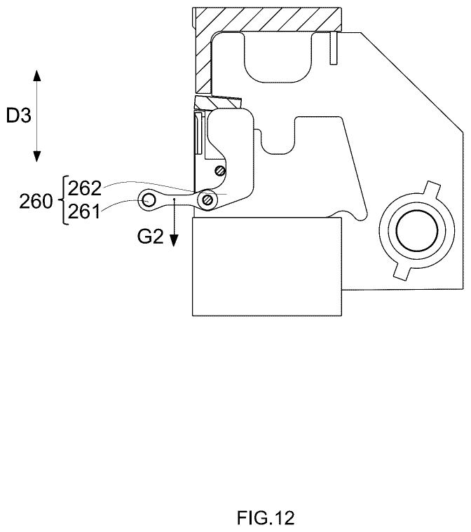

Referring to FIG. 12, in a second embodiment, in a case where an operating member 260 is in the first flipped position and the second flipped position, along the second horizontal direction D2, a center of gravity of the operating member 260 is located at the side of the axis of the flipping pivot shaft away from the outer hinge shaft hole (G2 in FIG. 10 is the location of the center of gravity of the operating member 260). In this way, when the operating member 260 is in the first flipped position and no external force is applied to the operating portion 261, the operating member 260 will always be located at the first flipped position under the action of its own gravity as well as the action of the blocking portion (when the locking assembly is in the locked position). In the case where the operation member 260 is in the second flipped position, in the absence of an external force acting on the operation member 260, the locking assembly returns to the locked position under the action of its own gravity, and the operation member 260 flips to and remains at the first flipped position under the action of the locking assembly. As a result, it may be convenient for a user to directly operate the operating member 260 to cause the mating portion 262 to push the blocking portion. In this case, if the operating member 260 is not required to be used, those skilled in the art may flexibly select a fixing method to secure the operating member 260 in the stowed position.

The present disclosure has been described through the above-mentioned embodiments, but it should be understood that the above-mentioned embodiments are only for the purpose of illustration and description, and are not intended to limit the present disclosure to the scope of the described embodiments. Furthermore, those skilled in the art may understand that the present disclosure is not limited to the above-mentioned embodiments. More variations and modifications may be made according to the teachings of the present disclosure. All these variations and modifications fall within the protection scope claimed by the present disclosure. The protection scope of the present disclosure is defined by the appended claims and their equivalents.

Unless otherwise defined, the technical and scientific terms used herein have the same meanings as commonly understood by those skilled in the technical field of the present disclosure. The terms used herein are only for describing specific implementation purposes, and are not intended to limit the present disclosure. The term such as “parts” appearing herein may mean a single part or a combination of multiple parts. Terms such as “installing”, “disposing” and the like appearing herein may mean that one component is directly attached to another component, or that one component is attached to another component through an intermediate component. A feature described in one embodiment herein may be applied to another embodiment alone or in combination with other features, unless the feature is not applicable in the other embodiment or otherwise stated.

1. A hinge device for a foldable container, comprising:
a fixed hinge;
a movable hinge pivotally connected to the fixed hinge between a horizontal position and a vertical position about a hinge pivot shaft with an axial direction parallel to a first horizontal direction; and
a locking assembly pivotally connected to the fixed hinge about a locking pivot shaft with an axial direction parallel to the first horizontal direction to be able to rotate to a locked position,
wherein the locking assembly comprises a bracket and a locking block, the bracket comprises a pair of side plates spaced apart along the first horizontal direction and disposed in the fixed hinge, the movable hinge is located between the pair of side plates, the locking block is provided with a locking shaft, an axial direction of the locking shaft is parallel to the first horizontal direction, and the locking shaft is set to movably pass between the pair of side plates;
during a rotation of the movable hinge from the horizontal position to the vertical position, the locking assembly in the locked position can be pushed to rotate such that a part of the movable hinge rotated to the vertical position is located below the locking block, thereby enabling the locking block to block a rotation of the movable hinge from the vertical position to the horizontal position.

2. The hinge device of claim 1, wherein each side plate is provided with a retaining hole through which the locking shaft is set to pass, the dimension of the retaining hole is larger than an outer diameter dimension of the locking shaft, such that the locking shaft is movable along any direction within a movement plane perpendicular to the first horizontal direction.

3. The hinge device of claim 2, wherein the retaining hole is an elongated hole, and a long axis of the elongated hole is parallel to a height direction of the fixed hinge in a case where the locking assembly is in the locked position.

4. The hinge device of claim 1, wherein the locking block has an accommodating hole with an axial direction parallel to the first horizontal direction and a positioning hole with an axial direction perpendicular to the first horizontal direction, the positioning hole is communicated to the accommodating hole, the locking assembly further comprises a fastener, the locking shaft is set to pass through the accommodating hole, and the fastener is set to pass through the positioning hole and abuts against the locking shaft.

5. The hinge device of claim 1, wherein,
the fixed hinge is provided with an avoidance hole, the locking assembly is provided with a blocking portion extending along the first horizontal direction, the blocking portion and the locking pivot shaft are spaced apart, and the blocking portion extends and protrudes to a first side of the fixed hinge along the first horizontal direction after passing through the avoidance hole; and
the hinge device further comprises an operating member comprising a mating portion located at the first side of the fixed hinge along the first horizontal direction, the operating member is pivotally connected to the fixed hinge or to the locking assembly about a flipping pivot shaft with an axial direction parallel to the first horizontal direction, and the mating portion is rotatable to a side of the blocking portion along a second horizontal direction perpendicular to the first horizontal direction such that the mating portion is capable of driving the locking assembly to rotate away from the locked position via the blocking portion.

6. The hinge device of claim 5, wherein the operating member further comprises an operating portion, the mating portion comprises a first wall and a second wall connected to the first wall, one end of the second wall is connected to the operating portion, length directions of the first wall and the second wall are both perpendicular to the first horizontal direction, a length direction of the operating portion extends along the first horizontal direction, and the first wall is used to push the blocking portion to drive the locking assembly to rotate away from the locked position.

7. The hinge device of claim 6, wherein the operating member passes through a stowed position, a first flipped position and a second flipped position in sequence during a rotation of the operating member about the flipping pivot shaft in a clockwise direction or in a counterclockwise direction;
in a case where the operating member is in the stowed position, the operating member is located at an inner side of an outer end of the fixed hinge along the second horizontal direction, and the first wall is spaced apart from the blocking portion;
in a case where the operating member is in the first flipped position, the operating portion is located at an outer side of the fixed hinge along the second horizontal direction, the blocking portion is located between the operating portion and the first wall, the first wall abuts against the blocking portion, and the locking assembly is in the locked position; and
in a case where the operating member is in the second flipped position, the first wall abuts against the blocking portion, and the locking assembly is in a released position.

8. The hinge device of claim 7, wherein,
in the case where the operating member is in the first flipped position, the second wall is located below the first wall, and the flipping pivot shaft is located between the operating portion and the first wall along the second horizontal direction, and/or
in the case where the operating member is in the stowed position, the blocking portion is located at a side of the second wall and fits against the second wall, thereby blocking the operating member from rotating away from the first flipped position.

9. The hinge device of claim 7, wherein the operating member is capable of stopping at the stowed position or at the first flipped position under the action of gravity of the operating member.

10. The hinge device of claim 5, wherein the flipping pivot shaft and the locking pivot shaft are provided coaxially or spaced apart.

11. The hinge device claim 5, wherein,
the fixed hinge comprises a wall plate, a bottom corner piece connected to a lower end of the wall plate and a supporting plate, there is a spacing between a fixed inner side surface of the wall plate and a corner piece inner side surface of the bottom corner piece along the first horizontal direction, the supporting plate fits against the fixed inner side surface, a supporting inner side surface of the supporting plate is flush with the corner piece inner side surface along the first horizontal direction, and the mating portion fits against the supporting plate, and/or
the side plates comprise an outer side plate and an inner side plate spaced apart along the first horizontal direction, and the bracket further comprises a connecting member connected to the top of an outer end of the outer side plate and to the top of an outer end of the inner side plate.

12. A foldable container, comprising the hinge device of claim 1.
